(19) United States
(12) Patent Application Publication
(10) Pub. No.: US 2019/0371172 A1
(43) Pub. Date: Dec. 5, 2019

(54) CONTROL DEVICE AND COMPUTER-READABLE STORAGE MEDIUM

(71) Applicant: HONDA MOTOR CO.,LTD., Tokyo (JP)

(72) Inventors: Mutsumi KATAYAMA, Saitama (JP); Naohide AIZAWA, Tokyo (JP)

(21) Appl. No.: 16/430,450

(22) Filed: Jun. 4, 2019

(30) Foreign Application Priority Data
Jun. 4, 2018 (JP) 2018-107008

(51) Int. Cl. G08G 1/0967; H04N 7/18; B60R 1/00

(52) U.S. Cl. CPC G08G 1/096791; B60R 1/00; H04N 7/181

(57) ABSTRACT

A control device is provided, the control device including: a positional information acquiring unit that acquires information indicating a position of a first vehicle; a vehicle selecting unit that selects one vehicle from a plurality of vehicles travelling on a road; an image receiving unit that receives a captured image captured by the one vehicle selected by the vehicle selecting unit; and a display control unit that causes the captured image received by the image receiving unit to be displayed, wherein every time the vehicle selecting unit receives an indication of predetermined manipulation, the vehicle selecting unit selects a vehicle located farther from the position of the first vehicle.

The contents of the following Japanese patent application are incorporated herein by reference: NO. 2018-107008 filed in JP on Jun. 4, 2018

### BACKGROUND

### 1. Technical Field

The present invention relates to a control device, and a computer-readable storage medium.

### 2. Related Art

There are known vehicle-mounted systems having means that receive information indicating an observation point (geographical point) selected by a user, request a second vehicle-mounted system to capture an image of the observation point, receive the image of the observation point from the second vehicle-mounted system, and display the image (please see Patent Literature 1, for example).

### PRIOR ART LITERATURE

### Patent Literature

[Patent Literature 1] Japanese Patent Application Publication No. 2006-031583

### SUMMARY

It is desirable to provide a technique that enables appropriate selection of captured images useful for viewers in situations where a number of vehicles share captured images.

### BRIEF DESCRIPTION OF THE DRAWINGS

FIG. 1 schematically illustrates an exemplary communication environment of vehicles 100.

FIG. 2 schematically illustrates an exemplary configuration of a user vehicle 100.

FIG. 3 schematically illustrates exemplary vehicles to be selected by a control device 200 of the user vehicle 100.

FIG. 4 schematically illustrates exemplary vehicles to be selected by the control device 200 of the user vehicle 100.

FIG. 5 schematically illustrates exemplary vehicles to be selected by the control device 200 of the user vehicle 100.

FIG. 6 is an explanatory diagram for explaining calculation of a wet area 420.

FIG. 7 is an explanatory diagram for explaining calculation of a wet area 420.

FIG. 8 schematically illustrates exemplary vehicles to be selected by the control device 200 of the user vehicle 100.

FIG. 9 schematically illustrates an exemplary functional configuration of the control device 200.

FIG. 10 schematically illustrates an exemplary hardware configuration of a computer 1000 to function as the control device 200.

FIG. 11 schematically illustrates an exemplary functional configuration of a communication terminal 600.

FIG. 12 schematically illustrates an exemplary hardware configuration of a computer 1100 to function as the communication terminal 600.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

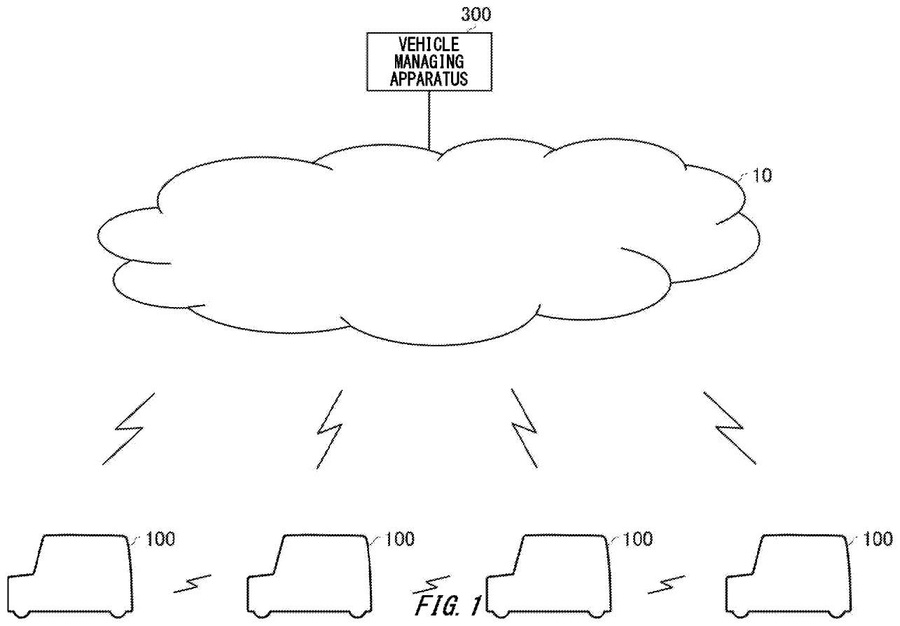

FIG. 1 schematically illustrates an exemplary communication environment of a user vehicle 100 according to the present embodiment. The user vehicle 100 wirelessly communicates with non-user vehicles 100. The user vehicle 100 may wirelessly communicate with a non-user vehicle 100 using at least any one of: wireless communication with the non-user vehicle 100 through a network 10; direct wireless communication (which may be in some cases referred to as vehicle-to-vehicle direct communication) with the non-user vehicle 100; and wireless communication (which may be in some cases referred to as vehicle-to-infrastructure communication) with the non-user vehicle 100 through vehicle-to-infrastructure communication.

The network 10 may be any network. For example, the network 10 may include at least any one of the internet, a mobile phone network such as a so-called 3G (3rd Generation) network, LTE (Long Term Evolution) network, 4G (4th Generation) network, or 5G (5th Generation) network, a public wireless LAN (Local Area Network), and a dedicated network.

The user vehicle 100 may use any known vehicle-to-vehicle communication technique and/or vehicle-to-infrastructure communication technique, and execute vehicle-to-vehicle direct communication and/or vehicle-to-infrastructure communication. For example, the user vehicle 100 executes vehicle-to-vehicle direct communication or vehicle-to-infrastructure communication through communication utilizing a predetermined frequency band such as the 700 MHz band or 5.8 GHz band. The user vehicle 100 may wirelessly communicate with a non-user vehicle 100 via another non-user vehicle 100. For example, a plurality of vehicles 100 may cooperate through vehicle-to-vehicle direct communication and/or vehicle-to-infrastructure communication to thereby form an inter-vehicle network, and remote vehicles 100 may execute communication with each other through the inter-vehicle network.

A vehicle managing apparatus 300 manages a plurality of vehicles 100. The vehicle managing apparatus 300 may manage vehicle information about each of the plurality of vehicles 100. The vehicle information may include the position of a vehicle 100. The vehicle information may include the travel situation of a vehicle 100. For example, the vehicle information includes the advancing direction, travel speed and the like of a vehicle 100. In addition, for example, the vehicle information includes route information indicating a route to a destination of a vehicle 100. In addition, for example, the vehicle information includes contents of manipulation being performed in a vehicle 100. Exemplary contents of manipulation include contents of wheel manipulation, contents of accelerator manipulation, contents of brake manipulation, contents of wiper manipulation, contents of inside/outside air selection switch manipulation, contents of manipulation on a manipulation panel provided to a vehicle 100, and the like that are being performed in the vehicle 100. The vehicle managing apparatus 300 may regularly receive various types of vehicle information from vehicles 100 through the network 10.

The user vehicle 100 may receive vehicle information from the vehicle managing apparatus 300 to thereby grasp situations encountered by non-user vehicles. In addition, the user vehicle 100 may receive various types of vehicle information from non-user vehicles 100 through at least any one of vehicle-to-vehicle direct communication, vehicle-to-infrastructure communication, and an inter-vehicle network.

Vehicles 100 according to the present embodiment include image-capturing units that capture images of the space around themselves. The vehicles 100 send captured images captured by the image-capturing units to the vehicle managing apparatus 300 or to other vehicles 100. In addition, vehicles 100 receive captured images captured by image-capturing units of other vehicles 100 from those vehicles 100 or from the vehicle managing apparatus 300. In this manner, the plurality of vehicles 100 share captured images. The captured images may be still images or videos (moving images).

Here, since, if a number of vehicles 100 share captured images, the number of images not useful for viewers also increases, it is desirable to provide a technique that enables appropriate selection of captured images useful for viewers.

Every time the user vehicle 100 according to the present embodiment receives an indication of predetermined manipulation by a user, the user vehicle 100 selects a vehicle located farther from the position of the user vehicle 100, receives a captured image captured by the selected vehicle, and displays the image. For example, every time a button on a manipulation unit provided to the user vehicle 100 is pressed, the user vehicle 100 sequentially selects the first vehicle 100 from vehicles which are no shorter than a predetermined distance ahead of the user vehicle 100 along the advancing direction of the user vehicle 100. As the predetermined distance, for example, 50 m, 200 m or the like may be selected arbitrarily, and in addition the predetermined distance may be changeable. Thereby, if the user desires to check the situations of locations ahead of the user vehicle 100 along the advancing direction of the user vehicle 100, the distance to a location the situation of which is to be checked can be extended by the predetermined distance easily. In addition, thereby, a viewing environment that resembles the skip function of a HDD recorder, for example, can be provided.

In addition, for example, every time a button on a manipulation unit is pressed, the user vehicle 100 selects a vehicle from a group of mutually closely located vehicles sharing captured images, the group being different and away from such groups of mutually closely located vehicles to which previously selected vehicles belong. The user vehicle 100 receives a captured image captured by the selected vehicle, and displays the captured image. Thereby, it is possible to lower the possibility of unintentionally repetitively viewing less useful captured images due to unintentionally repetitively selecting vehicles that are close to each other, and are capturing images of mutually closely located places.

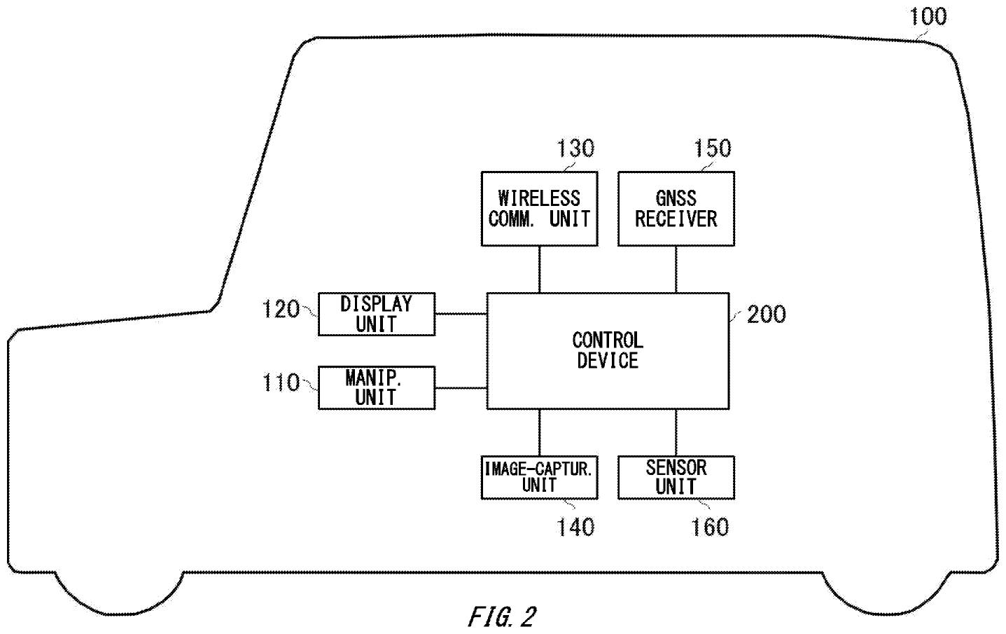

FIG. 2 schematically illustrates an exemplary configuration of the user vehicle 100. The user vehicle 100 includes a manipulation unit 110, a display unit 120, a wireless communication unit 130, an image-capturing unit 140, a GNSS (Global Navigation Satellite System) receiving unit 150, a sensor unit 160, and a control device 200. At least some of these configurations may be configurations included in a so-called car navigation system.

The manipulation unit 110 undergoes manipulation by a user of the user vehicle 100. The manipulation unit 110 may include physical manipulation buttons, and the like. The manipulation unit 110 and display unit 120 may be a touch panel display. The manipulation unit 110 may undergo audio manipulation. The manipulation unit 110 may include a microphone, and a speaker.

The wireless communication unit 130 executes wireless communication with non-user vehicles 100. The wireless communication unit 130 may include a communication unit that communicates with the network 10 through radio base stations in a mobile phone network. In addition, the wireless communication unit 130 may include a communication unit that communicates with the network 10 through WiFi (registered trademark) access points. In addition, the wireless communication unit 130 may include a communication unit that executes vehicle-to-vehicle communication. In addition, the wireless communication unit 130 may include a communication unit that executes vehicle-to-infrastructure communication.

The image-capturing unit 140 includes one or more cameras. The cameras may be a drive recorder. If the image-capturing unit 140 includes a plurality of cameras, the plurality of cameras are placed at different positions in the user vehicle 100. In addition, the plurality of cameras capture images in different image-capturing directions.

The GNSS receiving unit 150 receives radio waves emitted from a GNSS satellite. The GNSS receiving unit 150 may identify the position of the user vehicle 100 based on the signals received from the GNSS satellite.

The sensor unit 160 includes one or more sensors. The sensor unit 160 includes an acceleration sensor, for example. The sensor unit 160 includes an angular velocity sensor (gyro sensor), for example. The sensor unit 160 includes a geomagnetic sensor, for example. The sensor unit 160 includes a vehicle speed sensor, for example.

The control device 200 controls the manipulation unit 110, display unit 120, wireless communication unit 130, image-capturing unit 140, GNSS receiving unit 150, and sensor unit 160, and executes various types of processing. The control device 200 executes navigation processes, for example. The control device 200 may execute navigation processes similar to navigation processes executed by known car navigation systems.

For example, the control device 200 identifies the current position of the user vehicle 100 based on output from the GNSS receiving unit 150, and sensor unit 160, reads out map data corresponding to the current position, and makes the display unit 120 display the map data. In addition, a destination is input to the control device 200 through the manipulation unit 110, and the control device 200 identifies recommended routes from the current position of the user vehicle 100 to the destination, and makes the display unit 120 display the recommended routes. If the control device 200 received an indication of selection of a route, the control device 200 gives directions about a course along which the user vehicle 100 should travel, through the display unit 120 and a speaker according to the selected route.

The control device 200 according to the present embodiment executes a process of selecting a vehicle from a plurality of non-user vehicles 100, receiving a captured image captured by the selected vehicle, and displaying the captured image. For example, the control device 200 establishes a communication connection with the selected non-user vehicle 100, and receives, from the non-user vehicle 100, a captured image captured by the non-user vehicle 100. In addition, for example, the control device 200 receives, from the vehicle managing apparatus 300, a captured image uploaded by the selected non-user vehicle 100 to the vehicle managing apparatus 300. The control device 200 may make the display unit 120 display the received captured image.

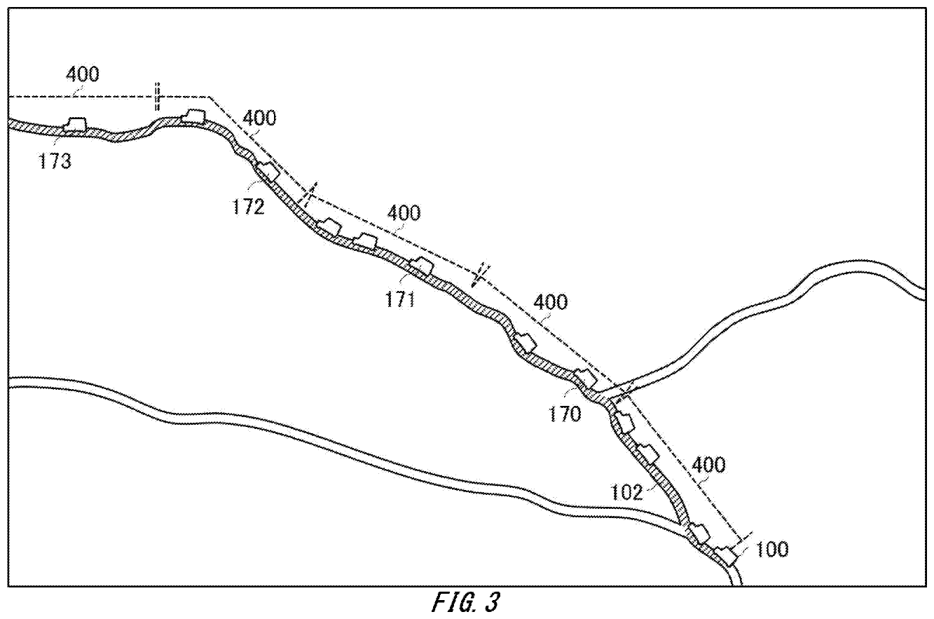

FIG. 3 schematically illustrates exemplary vehicles to be selected by the control device 200 of the user vehicle 100. The control device 200 may grasp the situation of non-user vehicles 100 based on vehicle information about the non-user vehicles 100 received from at least any one of the non-user vehicles 100 and the vehicle managing apparatus 300, and select a vehicle based on the situations of the non-user vehicles 100.

In the example explained here, the control device 200 selects a vehicle located at a distance, along a route 102 of the user vehicle 100, no shorter than a predetermined distance 400 multiplied by the number of times the control device 200 has received an indication of predetermined manipulation. The predetermined manipulation is, for example, pressing of a manipulation button provided to the manipulation unit 110. In addition, the predetermined manipulation may be selection of a button object displayed on the display unit 120 by a touch operation. In addition, the predetermined manipulation may be manipulation performed by inputting a predetermined audio command.

If the control device 200 undergoes the predetermined manipulation once, the control device 200 selects a vehicle closest to the user vehicle 100 among vehicles located at distances from the user vehicle 100 no shorter than the predetermined distance 400. The control device 200 may select a vehicle closest to the user vehicle 100 among non-user vehicles located at distances from the user vehicle 100 no shorter than the predetermined distance 400 along the routes between the user vehicle 100 and those non-user vehicles. In addition, the control device 200 may select a vehicle closest to the user vehicle 100 among vehicles located at straight line distances from the user vehicle 100 no shorter than the predetermined distance 400. In the example illustrated in FIG. 3, the control device 200 selects a vehicle 170. The control device 200 may receive a captured image captured by the vehicle 170, and make the display unit 120 display the captured image.

If the control device 200 further receives an indication of predetermined manipulation, the control device 200 selects a vehicle closest to the user vehicle 100 among vehicles located at distances from the user vehicle 100 no shorter than the predetermined distance 400 multiplied by two. In the example illustrated in FIG. 3, the control device 200 selects a vehicle 171. The control device 200 may receive a captured image captured by the vehicle 171, and make the display unit 120 display the captured image.

If the control device 200 further receives an indication of predetermined manipulation, the control device 200 selects a vehicle closest to the user vehicle 100 among vehicles located at distances from the user vehicle 100 no shorter than the predetermined distance 400 multiplied by three. In the example illustrated in FIG. 3, the control device 200 selects a vehicle 172. The control device 200 may receive a captured image captured by the vehicle 172, and make the display unit 120 display the captured image.

If the control device 200 further receives an indication of predetermined manipulation, the control device 200 selects a vehicle closest to the user vehicle 100 among vehicles located at distances from the user vehicle 100 no shorter than the predetermined distance 400 multiplied by four. In the example illustrated in FIG. 3, the control device 200 selects a vehicle 173. The control device 200 may receive a captured image captured by the vehicle 173, and make the display unit 120 display the captured image.

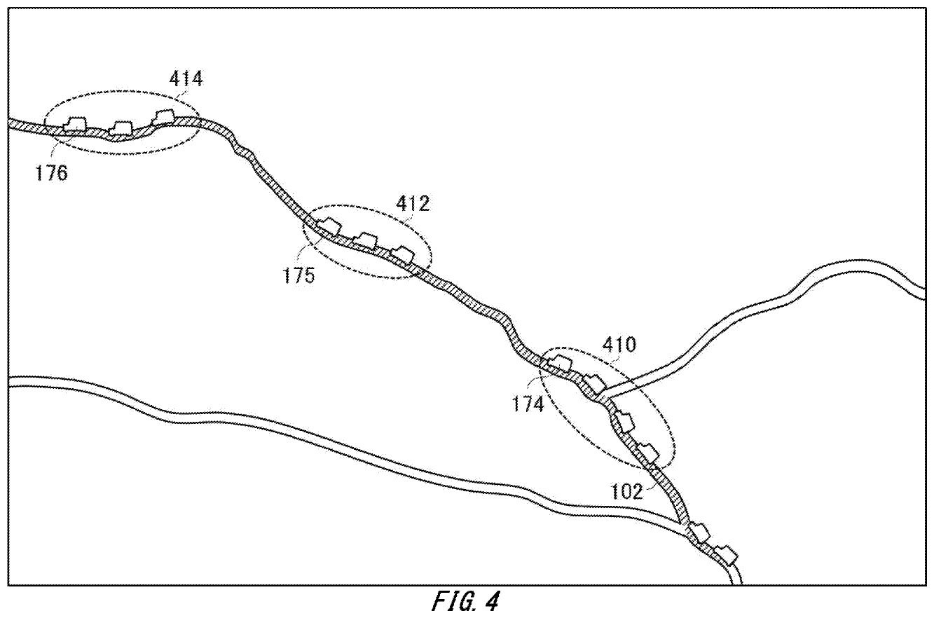

FIG. 4 schematically illustrates exemplary vehicles to be selected by the control device 200 of the user vehicle 100. In the example illustrated here, every time the control device 200 receives an indication of predetermined manipulation, the control device 200 selects a leading vehicle of a vehicle group located farther from the user vehicle 100 along the route 102 of the user vehicle 100. A vehicle group includes a plurality of vehicles, and an inter-vehicle distance between each pair of adjacent vehicles that are lined up along a road in the plurality of vehicles is not longer than a predetermined distance.

If the control device 200 receives an indication of predetermined manipulation once, the control device 200 selects a vehicle 174 that is a leading vehicle of a vehicle group 410. The control device 200 may receive a captured image captured by the vehicle 174, and make the display unit 120 display the captured image.

If the control device 200 further receives an indication of predetermined manipulation, the control device 200 selects a vehicle 175 that is a leading vehicle of a vehicle group 412 farther than the vehicle group 410. The control device 200 may receive a captured image captured by the vehicle 175, and make the display unit 120 display the captured image.

If the control device 200 further receives an indication of predetermined manipulation, the control device 200 selects a vehicle 176 that is a leading vehicle of a vehicle group 414 farther than the vehicle group 412. The control device 200 may receive a captured image captured by the vehicle 176, and make the display unit 120 display the captured image.

As illustrated in FIG. 4, selection of a leading vehicle of a vehicle group means selection of a vehicle beyond which there are no nearby vehicles, for example, and this enables reception and display of a captured image capturing an unobstructed view. In addition, it is possible to prevent repetitive selection of vehicles in a vehicle group.

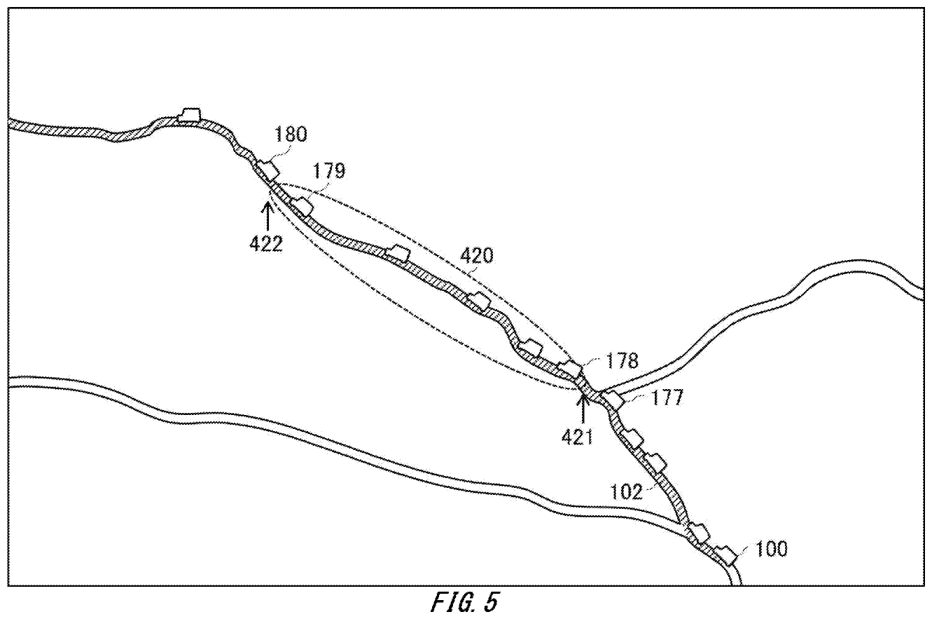

FIG. 5 schematically illustrates exemplary vehicles to be selected by the control device 200 of the user vehicle 100. In the example illustrated here, the control device 200 first selects a vehicle closest to a starting point 421 of a section that is part of the route 102 of the user vehicle 100, and is included in a wet area 420 where a road surface is likely to be wet, from a plurality of vehicles located between the starting point 421 and the position of the user vehicle 100. In the example illustrated in FIG. 5, the control device 200 first selects a vehicle 177. The control device 200 may receive a captured image captured by the vehicle 177, and make the display unit 120 display the captured image.

Then, every time the control device 200 receives an indication of predetermined manipulation, the control device 200 sequentially selects vehicles travelling in front of the vehicle 177 in order, starting from the one closest to the vehicle 177. In the example illustrated in FIG. 5, first, a vehicle 178 is selected, and, next, every time the control device 200 receives an indication of predetermined manipulation, vehicles travelling in front of the vehicle 178 are selected in order, starting from the one closest to the vehicle 178.

Thereby, even before entering the wet area 420, the control device 200 can successively check the situations of locations along the route into the wet area 420. Then, thereby, for example if the user vehicle 100 is an open car, it becomes possible to judge in advance up to which point the roof can be left open, and at which point the roof should be closed.

Note that the control device 200 may first select a vehicle closest to an end point 422 of the wet area 420 from a plurality of vehicles located between the end point 422 and the position of the user vehicle 100. In the example illustrated in FIG. 5, the control device 200 first selects a vehicle 179. The control device 200 may receive a captured image captured by the vehicle 179, and make the display unit 120 display the captured image.

Then, every time the control device 200 receives an indication of predetermined manipulation, the control device 200 selects vehicles travelling in front of the vehicle 179 in order, starting from the one closest to the vehicle 179. In the example illustrated in FIG. 5, first, a vehicle 180 is selected, and next vehicles travelling in front of the vehicle 180 are selected in order, starting from the one closest to the vehicle 180. Thereby, even before exiting from the wet area 420, the control device 200 can successively check the situations of locations along the route out of the wet area 420.

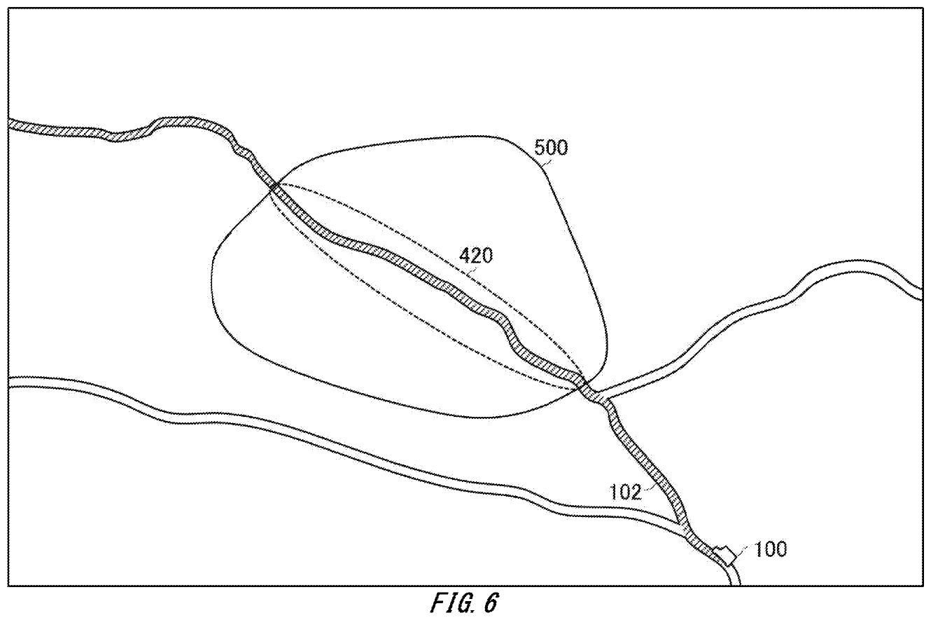

FIG. 6 is an explanatory diagram for explaining calculation of a wet area 420. The control device 200 may calculate, as a wet area 420, a section that is part of roads, and is included in a raining area 500, which means an area where it is raining. The control device 200 may receive information about the raining area 500 from a weather server or the like through the network 10, for example.

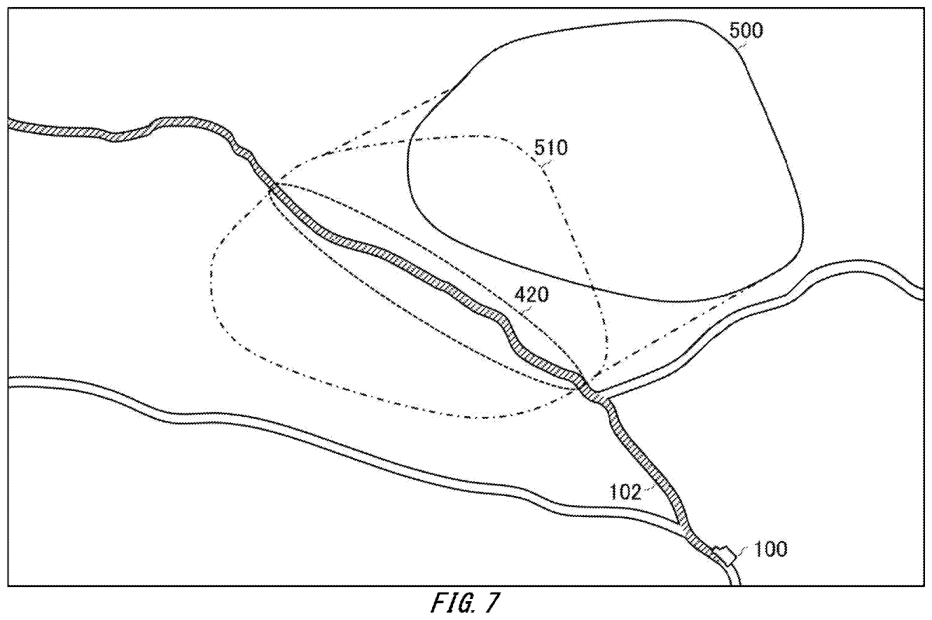

FIG. 7 is an explanatory diagram for explaining calculation of a wet area 420. The control device 200 may calculate a wet area 420 based on rain-related information indicating the temporal rain-related situation of each area. In the example illustrated in FIG. 7, a current raining area 500, and an area 510 that was a raining area one hour ago are illustrated.

Although the section of the wet area 420 is not included in the raining area 500 currently, the section was included in the area 510 that was a raining area one hour ago, and so the control device 200 can calculate that the section of the wet area 420 has a wet road surface. Note that the control device 200 may calculate a wet area 420 further based on at least any one of season, temperature, humidity, and precipitation.

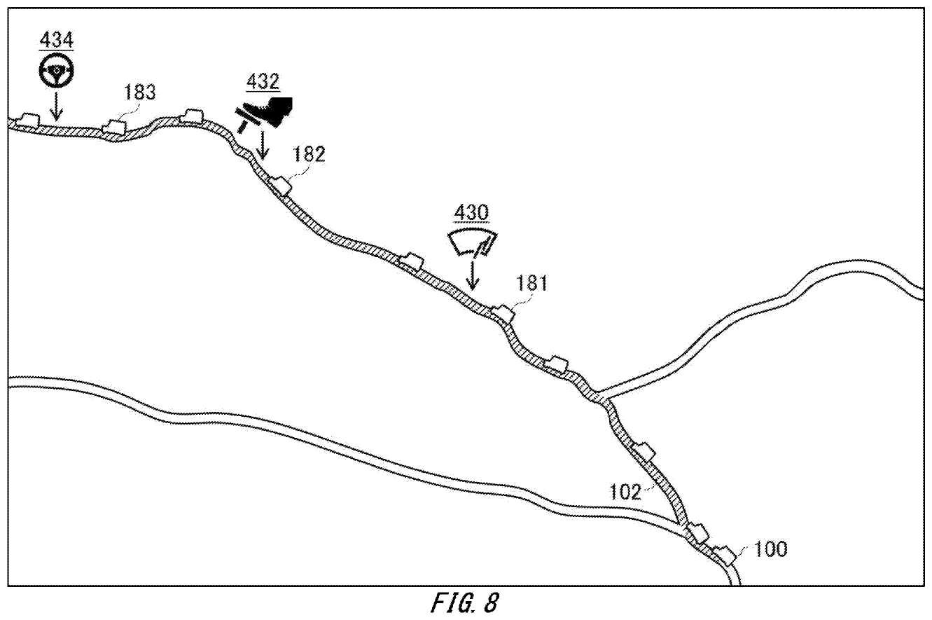

FIG. 8 schematically illustrates exemplary vehicles to be selected by the control device 200 of the user vehicle 100. In the example illustrated here, the control device 200 identifies a point at which predetermined manipulation has been performed in no smaller than a predetermined number of vehicles within a predetermined period, and selects a vehicle closest to the identified point from a plurality of vehicles located between the point and the position of the user vehicle 100 along the route 102.

If the control device 200 receives an indication of predetermined manipulation, the control device 200 selects a vehicle 181 closest to a specific point 430 from a plurality of vehicles located between the specific point 430 and the position of the user vehicle 100. In the example illustrated in FIG. 8, the specific point 430 is a point where wiper operation manipulation was performed in no smaller than a predetermined number of vehicles within a predetermined period. The control device 200 may receive a captured image captured by the vehicle 181, and make the display unit 120 display the captured image. The control device 200 may make the display unit 120 display also information indicating that it is a point where a plurality of vehicles performed wiper driving manipulation.

For example, if a plurality of vehicles drove their wipers at the same point in a situation where it is not raining, it can be calculated that it is likely that the road surface is wet at the point, and that water is splashed there. By the control device 200 making the display unit 120 display captured images captured by the vehicle 181, it becomes possible to specifically check how the actual situation is like at a point where there is such a possibility.

If the control device 200 further receives an indication of predetermined manipulation, the control device 200 selects a vehicle 182 closest to a specific point 432 from a plurality of vehicles located between the specific point 432 and the position of the user vehicle 100. In the example illustrated in FIG. 8, the specific point 432 is a point where sudden brake manipulation was performed in no smaller than a predetermined number of vehicles within a predetermined period. The control device 200 may receive a captured image captured by the vehicle 182, and make the display unit 120 display the captured image. The control device 200 may make the display unit 120 display also information indicating that it is a point where a plurality of vehicles performed sudden brake manipulation.

Since the specific point 432 is where sudden braking has been performed for a plurality of vehicles, it can be calculated that there is some obstacle such as a fallen hindrance at the point. By the control device 200 making the display unit 120 display captured images captured by the vehicle 182, it becomes possible to specifically check how the actual situation is like at a point where there can be some obstacle.

If the control device 200 further receives an indication of predetermined manipulation, the control device 200 selects a vehicle 183 closest to a specific point 434 from a plurality of vehicles located between the specific point 434 and the position of the user vehicle 100. In the example illustrated in FIG. 8, the specific point 434 is a point where sudden wheel manipulation was performed in no smaller than a predetermined number of vehicles within a predetermined period. The control device 200 may receive a captured image captured by the vehicle 183 and make the display unit 120 display the captured image. The control device 200 may make the display unit 120 display also information indicating that it is a point where a plurality of vehicles performed sudden wheel manipulation.

Since the specific point 434 is where sudden wheel manipulation has been performed for a plurality of vehicles, it can be calculated that there is some obstacle such as a fallen hindrance at the point. By the control device 200 making the display unit 120 display captured images captured by the vehicle 183, it becomes possible to specifically check how the actual situation is like at a point where there can be some obstacle.

Points such as the specific point 430, specific point 432, or specific point 434 may be decided by the control device 200. That is, the control device 200 may decide each point based on the situations encountered by a plurality of vehicles. In addition, points such as the specific point 430, specific point 432, or specific point 434 may be decided by the vehicle managing apparatus 300. The control device 200 may receive, from the vehicle managing apparatus 300, information about the specific point 430, specific point 432, and specific point 434 decided by the vehicle managing apparatus 300 to thereby identify these points.

Although in the example explained with reference to FIG. 8, every time the control device 200 receives an indication of predetermined manipulation, the control device 200 sequentially treats different types of specific points as target points, this is not the sole example. Every time the control device 200 receives an indication of predetermined manipulation, the control device 200 may treat the same type of specific points as target points. For example, if the control device 200 receives an indication of predetermined manipulation, the control device 200 selects a vehicle closest to a first specific point 434 from a plurality of vehicles located between the first specific point 434 and the position of the user vehicle 100, and if the control device 200 receives an indication of predetermined manipulation next, the control device 200 selects a vehicle closest to a second specific point 434 which is the second closest to the user vehicle 100 next to the first specific point 434 from a plurality of vehicles located between the second specific point 434 and the position of the user vehicle 100. In addition, every time the control device 200 receives an indication of predetermined manipulation, the control device 200 may treat a preselected type of specific points as target points.

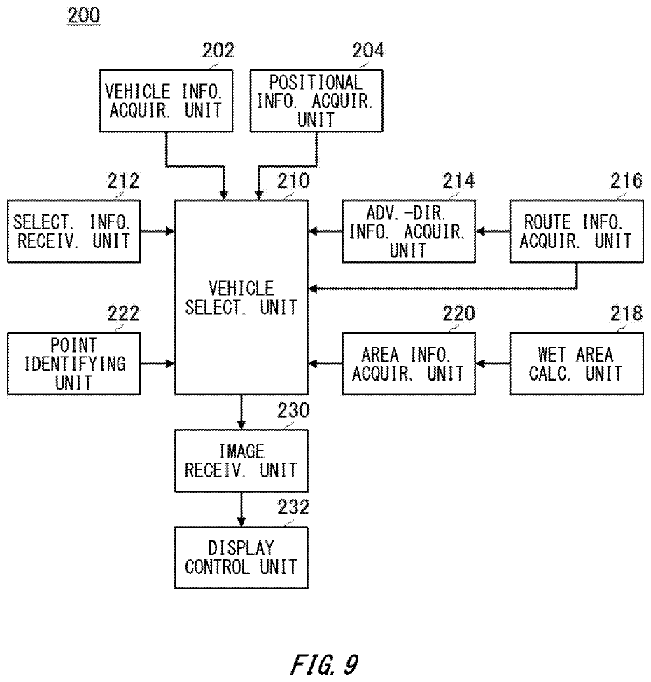

FIG. 9 schematically illustrates an exemplary functional configuration of the control device 200. The control device 200 includes a vehicle information acquiring unit 202, a positional information acquiring unit 204, a vehicle selecting unit 210, a selection information receiving unit 212, an advancing-direction information acquiring unit 214, a route information acquiring unit 216, a wet area calculating unit 218, an area information acquiring unit 220, a point identifying unit 222, an image receiving unit 230, and a display control unit 232. Note that the control device 200 is not necessarily required to include all these configurations.

The vehicle information acquiring unit 202 acquires vehicle information about non-user vehicles 100. The vehicle information acquiring unit 202 may receive the vehicle information from non-user vehicles 100. In addition, the vehicle information acquiring unit 202 may receive the vehicle information about a plurality of vehicles 100 from the vehicle managing apparatus 300.

The positional information acquiring unit 204 acquires information indicating the position of the user vehicle 100 on which the control device 200 is mounted. The positional information acquiring unit 204 may acquire information indicating the position from the GNSS receiving unit 150. In addition, the positional information acquiring unit 204 may acquire information indicating the user vehicle position based on output of the GNSS receiving unit 150, and sensor unit 160.

The vehicle selecting unit 210 selects one vehicle from a plurality of vehicles travelling on roads. For example, every time the vehicle selecting unit 210 receives an indication of predetermined manipulation through the manipulation unit 110, the vehicle selecting unit 210 selects a vehicle located farther from the user vehicle position. The vehicle selecting unit 210 may select a vehicle located at a distance no shorter than a predetermined distance multiplied by the number of times the vehicle selecting unit 210 has received an indication of predetermined manipulation.

The selection information receiving unit 212 receives information indicating selection of a predetermined distance. The selection information receiving unit 212 may receive information indicating selection of a predetermined distance through the manipulation unit 110. The vehicle selecting unit 210 may select a vehicle located at a distance no shorter than a predetermined distance indicated by information received by the selection information receiving unit 212 multiplied by the number of times the vehicle selecting unit 210 has received an indication of predetermined manipulation.

The advancing-direction information acquiring unit 214 acquires information indicating the user vehicle advancing direction. The advancing-direction information acquiring unit 214 may judge the user vehicle advancing direction based on changes of the user vehicle position. In addition, the advancing-direction information acquiring unit 214 may judge the user vehicle advancing direction by acquiring contents of control about driving of the user vehicle. Every time the vehicle selecting unit 210 receives an indication of predetermined manipulation, the vehicle selecting unit 210 may select a vehicle located farther from the user vehicle position along the user vehicle advancing direction.

The route information acquiring unit 216 acquires route information indicating a route to a user vehicle destination. The route information indicates a route from the user vehicle position to the destination. The advancing-direction information acquiring unit 214 may acquire information indicating the advancing direction based on the route information acquired by the route information acquiring unit 216.

The wet area calculating unit 218 calculates a wet area. The wet area calculating unit 218 calculates, as a wet area, a raining area where it is raining, for example. In addition, the wet area calculating unit 218 may calculate a wet area based on rain-related information indicating the temporal rain-related situation of each area. The wet area calculating unit 218 calculates, as a wet area, an area where it was raining in the past period that started a predetermined length of time before the current time, even if the area is not included in a currently raining area, for example.

The wet area calculating unit 218 may calculate a wet area based on the temperature, humidity, and precipitation of each area. For example, the wet area calculating unit 218 calculates a current wet area by calculating, for an area where it is not currently raining, but was previously raining, a length of time required for its road surface to dry according to the temperature and humidity of the area, and the precipitation during the period when it was raining.

The area information acquiring unit 220 acquires area information indicating a wet area. The area information acquiring unit 220 may acquire area information indicating a wet area calculated by the wet area calculating unit 218.

The vehicle selecting unit 210 may identify a section that is part of a route indicated by route information acquired by the route information acquiring unit 216, and is included in a wet area, and select a vehicle closest to a starting point of the section from a plurality of vehicles located between the starting point and the user vehicle position in the route. After selecting the vehicle, every time the vehicle selecting unit 210 receives an indication of predetermined manipulation, the vehicle selecting unit 210 may select a vehicle located farther from the previously selected vehicle along the route indicated by the route information.

The vehicle selecting unit 210 may identify a section that is part of a route indicated by route information acquired by the route information acquiring unit 216, and is included in a wet area, and select a vehicle closest to an end point of the identified section from a plurality of vehicles located between the end point and the user vehicle position in the route. After selecting the vehicle, every time the vehicle selecting unit 210 receives an indication of predetermined manipulation, the vehicle selecting unit 210 may select a vehicle located farther from the previously selected vehicle along the route indicated by the route information.

The point identifying unit 222 identifies a point at which predetermined manipulation has been performed in no smaller than a predetermined number of vehicles within a predetermined period. The point identifying unit 222 identifies a point at which predetermined wheel manipulation has been performed in no smaller than a predetermined number of vehicles within a predetermined period, for example. In addition, the point identifying unit 222 identifies a point at which predetermined brake manipulation has been performed in no smaller than a predetermined number of vehicles within a predetermined period, for example. In addition, the point identifying unit 222 identifies a point at which predetermined wiper manipulation has been performed in no smaller than a predetermined number of vehicles within a predetermined period, for example. In addition, the point identifying unit 222 identifies a point at which predetermined inside/outside air selection switch manipulation has been performed in no smaller than a predetermined number of vehicles within a predetermined period, for example. Note that these are mentioned as examples, and the point identifying unit 222 may identify a point at which predetermined manipulation other than them has been performed.

The point identifying unit 222 may identify a point based on information about non-user vehicles received from non-user vehicles 100, and information about non-user vehicles received from the vehicle managing apparatus 300. In addition, the point identifying unit 222 may identify a point by receiving, from the vehicle managing apparatus 300, information indicating a point identified by the vehicle managing apparatus 300.

The vehicle selecting unit 210 may select a vehicle closest to the point identified by the point identifying unit 222 from a plurality of vehicles located between the point and the user vehicle position in the route indicated by the route information.

The image receiving unit 230 receives a captured image captured by a vehicle selected by the vehicle selecting unit 210. The image receiving unit 230 may receive a captured image from the vehicle. In addition, the image receiving unit 230 may receive, from the vehicle managing apparatus 300, a captured image captured by the vehicle, and uploaded to the vehicle managing apparatus 300.

The display control unit 232 causes a captured image received by the image receiving unit 230 to be displayed. The display control unit 232 makes the display unit 120 display the captured image, for example. In addition, the display control unit 232 may send the captured image to a preselected communication terminal, and make the communication terminal display the captured image. Exemplary communication terminals include a mobile phone such as a smartphone, a tablet terminal, and the like that are owned by a user of the user vehicle.

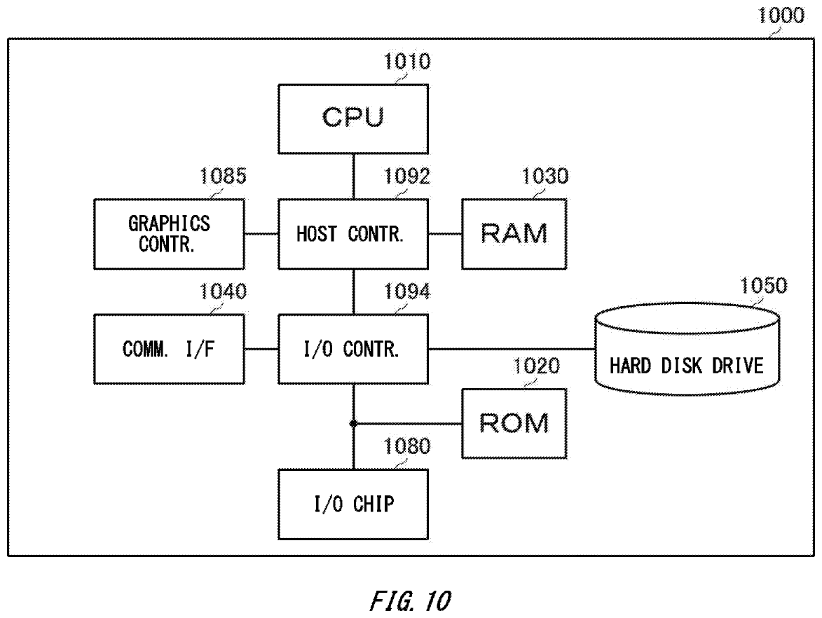

FIG. 10 schematically illustrates an exemplary computer 1000 to function as the control device 200. The computer 1000 according to the present embodiment includes: a CPU peripheral unit having a CPU 1010, a RAM 1030, and a graphics controller 1085 that are interconnected by a host controller 1092; and an input/output unit having a ROM 1020, a communication I/F 1040, a hard disk drive 1050, and an input/output chip 1080 that are connected to the host controller 1092 by an input/output controller 1094.

The CPU 1010 performs operations based on programs stored in the ROM 1020 and RAM 1030, and performs control of each unit. The graphics controller 1085 acquires image data generated by the CPU 1010 or the like on a frame buffer provided in the RAM 1030, and makes a display display the image data. Instead of this, the graphics controller 1085 may include therein a frame buffer to store image data generated by the CPU 1010 or the like.

The communication I/F 1040 communicates with another device via a network through a wired or wireless connection. In addition, the communication I/F 1040 functions as hardware to perform communication. The hard disk drive 1050 stores programs and data to be used by the CPU 1010.

The ROM 1020 stores a boot-program to be executed by the computer 1000 at the time of activation, and programs or the like that depend on hardware of the computer 1000. The input/output chip 1080 connects various types of input/output devices to the input/output controller 1094 through, for example, a parallel port, a serial port, a keyboard port, a mouse port, and the like.

Programs to be provided to the hard disk drive 1050 through the RAM 1030 are provided by a user in the form stored in a recording medium such as an IC card. The programs are read out from the recording medium, installed in the hard disk drive 1050 through the RAM 1030, and executed at the CPU 1010.

The programs that are installed in the computer 1000, and make the computer 1000 function as the control device 200 may act on the CPU 1010 or the like, and may each make the computer 1000 function as a unit(s) of the control device 200. Information processing described in these programs are read in by the computer 1000 to thereby function as the vehicle information acquiring unit 202, positional information acquiring unit 204, vehicle selecting unit 210, selection information receiving unit 212, advancing-direction information acquiring unit 214, route information acquiring unit 216, wet area calculating unit 218, area information acquiring unit 220, point identifying unit 222, image receiving unit 230, and display control unit 232, which are specific means attained by cooperation between software and various types of hardware resources mentioned above. Then, with these specific means, operations on or processing of information corresponding to a intended use of the computer 1000 in the present embodiment are realized to thereby construct the unique control device 200 corresponding to the intended use.

Although in the above-mentioned embodiment, the control device 200 mounted on the user vehicle 100 is explained as an exemplary control device, this is not the sole example. For example, a communication terminal owned by a user who is in the user vehicle 100 may function as the control device.

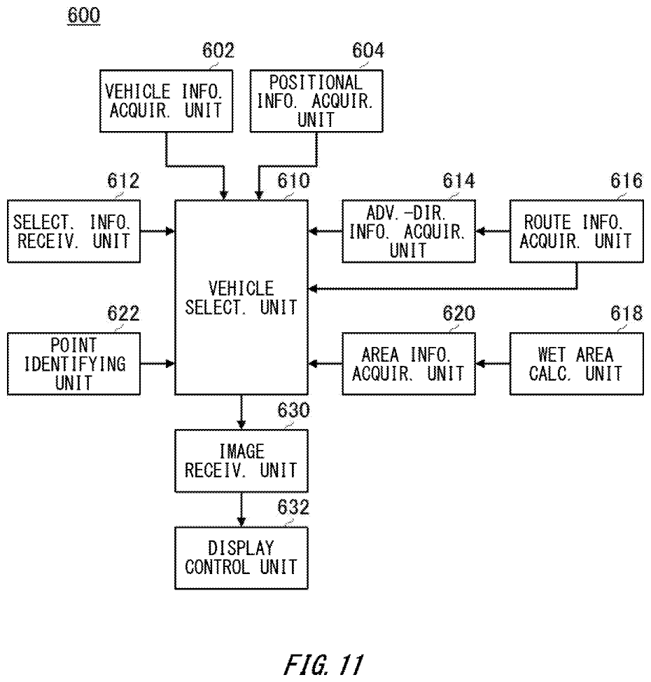

FIG. 11 schematically illustrates an exemplary functional configuration of a communication terminal 600. It includes a vehicle information acquiring unit 602, a positional information acquiring unit 604, a vehicle selecting unit 610, a selection information receiving unit 612, an advancing-direction information acquiring unit 614, a route information acquiring unit 616, a wet area calculating unit 618, an area information acquiring unit 620, a point identifying unit 622, an image receiving unit 630, and a display control unit 632. Note that the communication terminal 600 is not necessarily required to include all these configurations. Here, differences in terms of processing contents from those in the control device 200 illustrated in FIG. 8 are mainly explained.

The vehicle information acquiring unit 602 acquires vehicle information about non-user vehicles 100. It may receive vehicle information about a plurality of vehicles 100 from a user vehicle 100 in which a user owning the communication terminal 600 is, non-user vehicles 100, or the vehicle managing apparatus 300.

The positional information acquiring unit 604 acquires information indicating the user vehicle position. The positional information acquiring unit 604 may receive information indicating the user vehicle position from the user vehicle. The positional information acquiring unit 604 receives information indicating the user vehicle position from the user vehicle through near field communication such as Bluetooth (registered trademark) communication, for example. In addition, the positional information acquiring unit 604 may acquire, as information indicating the user vehicle position, information indicating a position measured by a position measurement function that the communication terminal 600 has.

The vehicle selecting unit 610 selects one vehicle from a plurality of vehicles travelling on roads. Every time the vehicle selecting unit 610 receives an indication of predetermined manipulation through a manipulation unit of the communication terminal 600, the vehicle selecting unit 610 selects a vehicle located farther from the user vehicle position. The selection information receiving unit 612 receives information indicating selection of a predetermined distance through the manipulation unit of the communication terminal 600.

The advancing-direction information acquiring unit 614 acquires information indicating the user vehicle advancing direction. The advancing-direction information acquiring unit 614 may receive information indicating the user vehicle advancing direction from the user vehicle. The route information acquiring unit 616 acquires user vehicle route information. The route information acquiring unit 616 may acquire route information from the user vehicle.

The wet area calculating unit 618 calculates a wet area. The area information acquiring unit 620 acquires area information indicating a wet area.

The point identifying unit 622 identifies a point at which predetermined manipulation has been performed in no smaller than a predetermined number of vehicles within a predetermined period. The point identifying unit 622 may identify a point based on information about non-user vehicles received from non-user vehicles 100, and information about non-user vehicles received from the vehicle managing apparatus 300. In addition, the point identifying unit 622 may identify a point by receiving, from the vehicle managing apparatus 300, information indicating a point identified by the vehicle managing apparatus 300.

The image receiving unit 630 receives a captured image captured by a vehicle selected by the vehicle selecting unit 610. The image receiving unit 630 may receive a captured image from the vehicle. In addition, the image receiving unit 630 may receive, from the vehicle managing apparatus 300, a captured image captured by the vehicle, and uploaded to the vehicle managing apparatus 300.

The display control unit 632 causes a captured image received by the image receiving unit 630 to be displayed. The display control unit 632 makes a display provided to the communication terminal 600 display the captured image, for example.

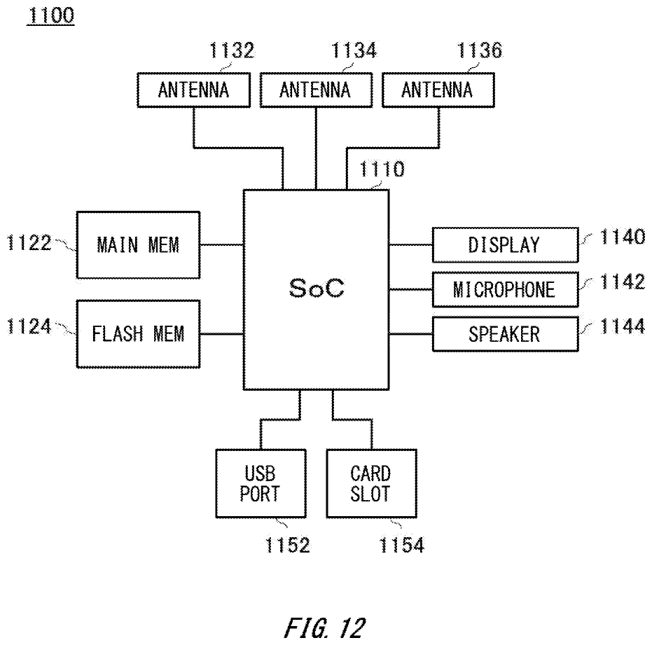

FIG. 12 illustrates an exemplary hardware configuration of a computer 1100 to function as the communication terminal 600. The computer 1100 according to the present embodiment includes an SoC 1110, a main memory 1122, a flash memory 1124, an antenna 1132, an antenna 1134, an antenna 1136, a display 1140, a microphone 1142, a speaker 1144, a USB port 1152, and a card slot 1154.

The SoC 1110 performs operation based on programs stored in the main memory 1122, and flash memory 1124, and performs control of each unit. The antenna 1132 is a so-called cellular antenna. The antenna 1134 is a so-called WiFi (registered trademark) antenna. The antenna 1136 is a so-called short range wireless communication antenna such as a Bluetooth (registered trademark) antenna. The SoC 1110 may use the antenna 1132, antenna 1134, and antenna 1136 to realize various types of communication functions. The SoC 1110 may use the antenna 1132, antenna 1134, or antenna 1136 to receive the programs that the SoC 1110 uses, and store the programs in the flash memory 1124.

The SoC 1110 may use the display 1140 to realize various types of display functions. The SoC 1110 may use the microphone 1142 to realize various types of audio input function. The SoC 1110 may use the speaker 1144 to realize various types of audio output function.

The USB port 1152 realizes USB connection. The card slot 1154 realizes connection with various types of cards such as an SD card. The SoC 1110 may receive the programs that the SoC 1110 uses from equipment or a memory connected to the USB port 1152, and from a card connected to the card slot 1154, and store the programs in the flash memory 1124.

The programs that are installed in the computer 1100, and make the computer 1100 function as the communication terminal 600 may act on the SoC 1110 or the like, and may each make the computer 1100 function as a unit(s) of the communication terminal 600. Information processing described in these programs are read in by the computer 1100 to thereby function as the vehicle information acquiring unit 602, positional information acquiring unit 604, vehicle selecting unit 610, selection information receiving unit 612, advancing-direction information acquiring unit 614, route information acquiring unit 616, wet area calculating unit 618, area information acquiring unit 620, point identifying unit 622, image receiving unit 630, and display control unit 632, which are specific means attained by cooperation between software and various types of hardware resources mentioned above. Then, with these specific means, operations on or processing of information corresponding to a intended use of the computer 1100 in the present embodiment are realized to thereby construct the unique communication terminal 600 corresponding to the intended use.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCE SYMBOLS

10: network; 100: vehicle; 102: route; 110: manipulation unit; 120: display unit; 130: wireless communication unit; 140: image-capturing unit; 150: GNSS receiving unit; 160: sensor unit; 170, 171, 172, 173, 174, 175, 176, 177, 178, 179, 180, 181, 182, 183: vehicle; 200: control device; 202: vehicle information acquiring unit; 204: positional information acquiring unit; 210: vehicle selecting unit; 212: selection information receiving unit; 214: advancing-direction information acquiring unit; 216: route information acquiring unit; 218: wet area calculating unit; 220: area information acquiring unit; 222: point identifying unit; 230: image receiving unit; 232: display control unit; 300: vehicle managing apparatus; 400: predetermined distance; 410: vehicle group; 412: vehicle group; 414: vehicle group; 420: wet area; 430: specific point; 432: specific point; 434: specific point; 500: raining area; 510: raining area; 600: communication terminal; 602: vehicle information acquiring unit; 604: positional information acquiring unit; 610: vehicle selecting unit; 612: selection information receiving unit; 614: advancing-direction information acquiring unit; 616: route information acquiring unit; 618: wet area calculating unit; 620: area information acquiring unit; 622: point identifying unit; 630: image receiving unit; 632: display control unit; 1000: computer; 1010: CPU; 1020: ROM; 1030: RAM; 1040: communication I/F; 1050: hard disk drive; 1080: input/output chip; 1085: graphics controller; 1092: host controller; 1094: input/output controller; 1100: computer; 1110: SoC; 1122: main memory; 1124: flash memory; 1132: antenna; 1134: antenna; 1136: antenna; 1140: display; 1142: microphone; 1144: speaker; 1152: USB port; 1154: card slot

What is claimed is:

1. A control device comprising:
a positional information acquiring unit that acquires information indicating a position of a first vehicle;
a vehicle selecting unit that selects one vehicle from a plurality of vehicles travelling on a road;
an image receiving unit that receives a captured image captured by the one vehicle selected by the vehicle selecting unit; and
a display control unit that causes the captured image received by the image receiving unit to be displayed, wherein
every time the vehicle selecting unit receives an indication of predetermined manipulation, the vehicle selecting unit selects a vehicle located farther from the position of the first vehicle.

2. The control device according to claim 1, wherein the vehicle selecting unit selects a vehicle located at a distance no shorter than a predetermined distance multiplied by the number of times the vehicle selecting unit has received the indication of the predetermined manipulation.

3. The control device according to claim 2, comprising a selection information receiving unit that receives information indicating selection of the predetermined distance, wherein
the vehicle selecting unit selects a vehicle located at a distance no shorter than the predetermined distance indicated by the information received by the selection information receiving unit multiplied by the number of times the vehicle selecting unit has received the indication of the predetermined manipulation.

4. The control device according to claim 1, wherein every time the vehicle selecting unit receives the indication of the predetermined manipulation, the vehicle selecting unit selects a leading vehicle of a vehicle group located farther from the position of the first vehicle.

5. The control device according to claim 4, wherein the vehicle group includes a plurality of vehicles, and an inter-vehicle distance between each pair of adjacent vehicles that are lined up along a road in the plurality of vehicles is not longer than a predetermined distance.

6. The control device according to claim 1, comprising an advancing-direction information acquiring unit that acquires information indicating an advancing direction of the first vehicle, wherein
every time the vehicle selecting unit receives the indication of the predetermined manipulation, the vehicle selecting unit selects a vehicle located farther from the position of the first vehicle along the advancing direction.

7. The control device according to claim 1, comprising a route information acquiring unit that acquires route information indicating a route from the position of the first vehicle to a destination of the first vehicle, wherein
every time the vehicle selecting unit receives the indication of the predetermined manipulation, the vehicle selecting unit selects a vehicle located farther from the position of the first vehicle along the route.

8. The control device according to claim 7, comprising an area information acquiring unit that acquires area information indicating a wet area where a road surface is likely to be wet, wherein
the vehicle selecting unit: identifies a section that is part of the route indicated by the route information, and is included in the wet area; and selects, as the one vehicle, a vehicle closest to a starting point of the section from a plurality of vehicles located between the starting point and the position of the first vehicle in the route.

9. The control device according to claim 7, comprising an area information acquiring unit that acquires area information indicating a wet area where a road surface is likely to be wet, wherein
after identifying a section that is part of the route indicated by the route information, and is included in the wet area, and selecting, as the one vehicle, a vehicle closest to a starting point of the section from a plurality of vehicles located between the starting point and the position of the first vehicle in the route, every time the vehicle selecting unit receives the indication of the predetermined manipulation, the vehicle selecting unit selects a vehicle located farther from the one vehicle along the route indicated by the route information.

10. The control device according to claim 8, wherein the vehicle selecting unit selects, as the one vehicle, a vehicle closest to an end point of the identified section from a plurality of vehicles located between the end point and the position of the first vehicle in the route.

11. The control device according to claim 10, wherein after selecting, as the one vehicle, a vehicle closest to an end point of the identified section from a plurality of vehicles located between the end point and the position of the first vehicle in the route, every time the vehicle selecting unit receives the indication of the predetermined manipulation, the vehicle selecting unit selects a vehicle located farther from the one vehicle along the route indicated by the route information.

12. The control device according to claim 8, wherein the area information acquiring unit acquires, as the wet area, a raining area where it is raining.

13. The control device according to claim 8, comprising a wet area calculating unit that calculates the wet area based on rain-related information indicating a temporal rain-related situation of each area, wherein
the area information acquiring unit acquires information indicating the wet area calculated by the wet area calculating unit.

14. The control device according to claim 7, comprising a point identifying unit that identifies a point at which predetermined manipulation has been performed in no smaller than a predetermined number of vehicles within a predetermined period, wherein
the vehicle selecting unit selects, as the one vehicle, a vehicle closest to the point identified by the point identifying unit from a plurality of vehicles located between the point and the position of the first vehicle in the route.

15. The control device according to claim 14, wherein the predetermined manipulation is at least any one of predetermined wheel manipulation, predetermined brake manipulation, predetermined wiper manipulation, and predetermined inside/outside air selection switch manipulation.

16. A non-transitory computer-readable storage medium having stored thereon a program for causing a computer to function as:
a positional information acquiring unit that acquires information indicating a position of a first vehicle;
a vehicle selecting unit that selects one vehicle from a plurality of vehicles travelling on a road, the vehicle selecting unit selecting, every time the vehicle selecting unit receives an indication of predetermined manipulation, a vehicle located farther from the position of the first vehicle;
an image receiving unit that receives a captured image captured by the one vehicle selected by the vehicle selecting unit; and
a display control unit that causes the captured image received by the image receiving unit to be displayed.
